(19) United States
(12) Patent Application Publication
(10) Pub. No.: US 2025/0347473 A1
(43) Pub. Date: Nov. 13, 2025

(54) ENERGY STORAGE ARTICLES AND METHODS FOR MAKING AND USING THE SAME

(71) Applicant: RedoxBlox, Inc., San Diego, CA (US)

(72) Inventors: James F. Klausner, San Diego, CA (US); Kelvin Randhir, San Diego, CA (US); Stefan Arzbacher, Dornbirn (AT); Priyatham Tumurugoti, San Diego, CA (US); Nima Rahmatian, San Diego, CA (US); Dane Boysen, San Diego, CA (US); Joerg Petrasch, Dornbirn (AT)

(21) Appl. No.: 19/203,412

(22) Filed: May 9, 2025

Related U.S. Application Data
(60) Provisional application No. 63/645,275, filed on May 10, 2024.

(51) Int. Cl. F28D 20/00; C09K 5/16

(52) U.S. Cl. CPC F28D 20/003; C09K 5/16; F28D 20/0056; F28D 2020/0017; F28D 2020/0021

(57) ABSTRACT

In accordance with the purpose(s) of the present disclosure, as embodied and broadly described herein, the disclosure, in one aspect, relates to energy storage articles. In one aspect, the energy storage articles are composed of a mixed metal oxide, wherein the mixed metal oxide (i) is reduced when heated to produce a reduced solid state while liberating oxygen and (ii) when in the reduced state, the mixed metal oxide is oxidized by exposing it to an oxygenated gas, and the mixed metal oxide is electrically conductive. The energy storage articles can be manufactured in a variety of different configurations to maximize the efficiency and effectiveness of the energy storage article.

### CROSS-REFERENCE TO RELATED APPLICATIONS

This application claims the benefit of and priority to co-pending U.S. Provisional Patent Application No. 63/645,275, filed on May 10, 2024, the contents of which are incorporated by reference herein in their entireties.

### BACKGROUND

Renewable energy sources such as wind and solar are necessary for decarbonizing electricity generation and industrial heat These energy resources are highly intermittent and vary with geographical location. As such, low cost, scalable and dispatchable energy storage is needed for reliable grid operation and industrial processing. The current energy storage technology gap necessitates the exploration of novel energy storage concepts and stable materials that can last for decades.

Energy storage is generally used to accommodate daily and seasonal imbalances in energy consumption and production. Power generation from renewable sources, such as solar and wind is inherently variable. Accordingly, renewable energy sources are best used in conjunction with energy storage systems that store energy when production exceeds demand, and release energy when demand exceeds production.

Some renewable energy systems, such as solar PV and wind turbines, use batteries to store electrical energy. Other storage systems include pumped hydro, compressed air, and flywheels, among others. Other renewable energy systems, such as concentrated solar power (CSP), incorporate thermal energy storage (“TES”). CSP plants typically incorporate sensible heat storage using materials such as molten salts, oil, sand, rock, or other particulate materials. Molten salt energy storage can have energy densities ranging from 500 to 780 MJ m⁻³. TES systems typically operate at temperatures of less than 600° C., limiting the exergy and thereby the thermal-to-electric conversion efficiency.

Some renewable energy systems incorporate thermochemical energy storage (“TCES”); however, many TCES systems have poor reactive stability (i.e., ability to be reused for thousands of cycles with negligible degradation in performance), moderate volumetric energy densities, and/or low energy discharge temperatures.

### SUMMARY

In accordance with the purpose(s) of the present disclosure, as embodied and broadly described herein, the disclosure, in one aspect, relates to energy storage articles. In one aspect, the energy storage articles are composed of a mixed metal oxide, wherein the mixed metal oxide (i) is reduced when heated to produce a reduced solid state while liberating oxygen and (ii) when in the reduced state, the mixed metal oxide is oxidized by exposing it to an oxygenated gas, and the mixed metal oxide is electrically conductive. The energy storage articles can be manufactured in a variety of different configurations to maximize the efficiency and effectiveness of the energy storage.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 shows an energy storage article as a brick.

FIG. 2 shows the cross-sectional view of a brick with gas passages.

FIG. 3 provides an energy storage article as a brick, where the openings for the gas passages are recessed.

FIG. 4 show the cross-sectional view of a brick with recessed gas passages.

FIG. 5 provides an energy storage article as a brick with a plurality of raised members.

FIG. 6 provides an energy storage article as a brick with interlocking members.

FIG. 7 shows two bricks interlocked with one another.

FIG. 8 shows the cross-sectional view of a brick with gas passages and openings for receiving a dowel.

FIG. 9 shows an energy storage article as a tile with a plurality of raised members

FIG. 10 shows the cross-sectional view of a tile with raised members on one side of the tile.

FIG. 11 shows the cross-sectional view of a tile with raised members on both sides of the tile.

FIG. 12 shows a die for producing bricks with a plurality of gas passages.

FIG. 13 shows a plurality of bricks in a stacked configuration.

FIG. 14 shows a cross-sectional view of a plurality of bricks in a stacked configuration.

FIG. 15 shows a plurality of tiles in a stacked configuration.

FIG. 16A shows a cross-sectional view of two tiles in a stacked configuration. FIG. 16B shows a plurality of tiles stacked in a three dimensional configuration.

FIG. 17 shows a cross-sectional view of a thermochemical energy storage device.

FIG. 18 shows 100 cycle data for Mg/Mn=1 bricks with apparent density of 2.9 g/cc (brick no. 2 in Table 2)

FIG. 19 shows oxygen exchange and energy density for bricks (Table 2) cycled 100 times in tube furnace.

FIG. 20 shows the resistivity and temperature vs. time for heating and cooling rates as provided in Table 1.

FIG. 21 shows resistivity vs. temperature for data shown in FIG. 20.

FIG. 22 shows the pressure drop and air flow rate for a 100 kWh unit discharging at constant 10 KW over 10 hours.

FIG. 23 shows refractoriness under load (RUL) data for composite MMO, pure MMO, and pure MgO.

FIGS. 24A-24C show (A) a monolith as an example of an energy storage device; (B) a cell composed of two monoliths connected to one another by a high-temperature electrically conductive ceramic plate; and (C) an assembly of cells with electrodes for use in a thermochemical energy storage device described herein.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an excipient” include, but are not limited to, mixtures or combinations of two or more such excipients, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range. Thus, for example, if a component is in an amount of about 1%, 2%, 3%, 4%, or 5%, where any value can be a lower and upper endpoint of a range, then any range is contemplated between 1% and 5% (e.g., 1% to 3%, 2% to 4%, etc.).

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the term “oxygenated gas” is any gas that includes oxygen. The oxygenated gas can include pure oxygen or a gas mixture composed of oxygen (e.g., air).

As used herein, the terms “optional” or “optionally” means that the subsequently described event or circumstance can or cannot occur, and that the description includes instances where said event or circumstance occurs and instances where it does not.

### Energy Storage Materials

The energy storage articles described herein are composed of materials that are thermochemically reactive. In one aspect, energy storage articles described herein are composed of a mixed metal oxide, wherein the mixed metal oxide (i) is reduced when heated to produce a reduced state while releasing oxygen and (ii) when in the reduced state, the mixed metal oxide is oxidized by exposing it to an oxygenated gas.

The mixed metal oxide releases oxygen upon being heated above a reduction temperature, and generates heat when exposed to oxygen below an oxidation temperature. More particularly, the energy storage material is a redox material that undergoes oxidation and reduction reactions. During charging, the energy storage material consumes heat to undergo reduction and releases oxygen. During discharging, the energy storage material consumes oxygen to undergo oxidation and generates heat. The energy storage material advantageously uses oxygen as a gaseous reactant, rather than CO₂, H₂, or CO, by way of example. The oxygen for the process may come from air.

The energy storage materials used herein provide several advantages with respect to energy storage. The energy storage materials are easily made from low cost/earth abundant materials. Low cost is a deciding factor for commercial deployment of any technology, particularly commercial energy storage and production. The energy storage materials can store and release the same amount of energy over many charge/discharge cycles, corresponding to a plant life on the order of several years to decades.

The energy storage materials used herein are electrically conductive in the temperature range relevant for the redox reaction. In certain aspects, the energy storage materials are heated by electricity provided by two or more electrodes connected to an electricity source. Passing an electric current through the energy storage material in the articles described herein results in Joule heating, where each of the energy storage articles are heated uniformly throughout their entire volume. This is contrasted with traditional heating using a heating element, which provides uneven heating via radiative and/or conductive heat transfer. Volumetric Joule heating is more uniform and allows for significantly larger heating power when compared to indirect heating by a heating element.

In another aspect, the energy storage materials have a high reactive stability (i.e., the ability to reuse the reactive material for thousands of cycles with negligible degradation in performance), high discharge temperature, and high energy density. Recycling of the energy storage material is another important feature with respect to providing cost-efficient energy storage. In one aspect, the energy storage material can be regenerated by subjecting the material to a chemical shock. For example, chemical shock can be accomplished by abrupt fast heating rates (>5° C./min) or by suddenly lowering the oxygen partial pressure at high temperatures (e.g., 1350° C.). In both cases, increased internal surface is generated. The energy storage material may need 1 or multiple negative oxygen chemical shock cycles to completely regain its reactivity.

In one aspect, the energy storage material is a mixed metal oxide. In one aspect, the mixed metal oxide is the reaction product between two or more metal oxides when heated in the presence of oxygen. In one aspect, particles or granules of the metal oxide are mixed so that the metal oxides are evenly dispersed. The mixture is subsequently heated in air at temperatures from about 1,000° C. to about 1,600° C.

In one aspect, the mixed metal oxide is the reaction product between manganese oxide and a metal oxide selected from the group consisting of magnesium oxide, calcium oxide, strontium oxide, barium oxide, yttrium oxide, cerium oxide, lanthanum oxide, and any combination thereof when heated in the presence of oxygen. In one aspect, manganese oxide is MnO, Mn₃O₄, Mn₂O₃, MnO₂, or any combination thereof.

In another aspect, the mixed metal oxide is the reaction product between iron oxide and a metal oxide selected from the group consisting of magnesium oxide, calcium oxide, strontium oxide, barium oxide, cerium oxide, lanthanum oxide, and any combination thereof when heated in the presence of oxygen. In one aspect, the iron oxide is FeO, Fe₃O₄, Fe₂O₃, or any combination thereof.

In another aspect, the mixed metal oxide is the reaction product between cobalt oxide and a metal oxide selected from the group consisting of magnesium oxide, calcium oxide, strontium oxide, barium oxide, cerium oxide, lanthanum oxide, and any combination thereof when heated in the presence of oxygen. In one aspect, cobalt oxide is CoO, Co₃O₄, or any combination thereof.

In one aspect, the mixed metal oxide comprises the reaction product between manganese oxide (MnO) and magnesium oxide (MgO) when heated in the presence of oxygen. Magnesium oxide and manganese oxide react to form magnesium-manganate spinel (MgMn₂O₄) (both cubic and tetragonal) when heated in the presence of oxygen (e.g., from air). A molar ratio of manganese to magnesium can be adjusted for a specific operating temperature range to obtain high reactive stability. In general, increasing an amount of magnesium decreases slag formation (inhibiting undesirable sintering of the energy storage material when heated) and facilitates operation of the energy storage device at higher temperatures. The molar ratio of manganese to magnesium ranges from about 1:4 to 4:1, or 1:4, 1:3.5, 1:3, 1:2.5, 1:2, 1:1.5, 1:1, 1:0.5, 0.5:1, 1.5:1, 2:1, 2.5:1, 3:1, 3.5:1, or 4:1, where any value can be a lower and upper endpoint of a range (e.g., 1.5:1 to 1:1.5).

In one aspect, the mixed metal is produced from two metal oxides (i.e., a binary mixed metal oxide). In one aspect, the binary mixed metal oxide is a selected from the table below.

| | | | | |
|---|---|---|---|---|
| 1 | Magnesium oxide | Manganese oxide | Spinel | (Mg, Mn)[Mg, Mn]₂O₄ |
| | (MgO) | (MnO/Mn₃O₄/Mn₂O₃/MnO₂) | | |
| 2 | Calcium oxide | Manganese oxide | Perovskite | CaMnO_{3-δ} |
| | (CaO) | (MnO/Mn₃O₄/Mn₂O₃/MnO₂) | | |
| 3 | Strontium oxide | Manganese oxide | Perovskite | SrMnO_{3-δ} |
| | (SrO) | (MnO/Mn₃O₄/Mn₂O₃/MnO₂) | | |
| 4 | Barium oxide | Manganese oxide | Perovskite | BaMnO_{3-δ} |
| | (BaO) | (MnO/Mn₃O₄/Mn₂O₃/MnO₂) | | |
| 5 | Yttrium oxide | Manganese oxide | Perovskite | YMnO_{3-δ} |
| | (Y₂O₃) | (MnO/Mn₃O₄/Mn₂O₃/MnO₂) | | |
| 6 | Cerium oxide | Manganese oxide | Perovskite | CeMnO_{3-δ} |
| | (CeO₂) | (MnO/Mn₃O₄/Mn₂O₃/MnO₂) | | |
| 7 | Lanthanum oxide | Manganese oxide | Perovskite | LaMnO_{3-δ} |
| | (La₂O₃) | (MnO/Mn₃O₄/Mn₂O₃/MnO₂) | | |
| 8 | Magnesium oxide | Iron oxide (Fe₃O₄/Fe₂O₃) | Spinel | (Mg, Fe)[Mg, Fe]₂O₄ |
| | (MgO) | | | |
| 9 | Calcium oxide | Iron oxide (Fe₃O₄/Fe₂O₃) | Perovskite | CaFeO_{3-δ} |
| | (CaO) | | | |
| 10 | Strontium oxide | Iron oxide (Fe₃O₄/Fe₂O₃) | Perovskite | SrFeO_{3-δ} |
| | (SrO) | | | |
| 11 | Barium oxide | Iron oxide (Fe₃O₄/Fe₂O₃) | Perovskite | BaFeO_{3-δ} |
| | (BaO) | | | |
| 12 | Cerium oxide | Iron oxide (Fe₃O₄/Fe₂O₃) | Perovskite | CeFeO_{3-δ} |
| | (CeO₂) | | | |
| 13 | Lanthanum oxide | Iron oxide (Fe₃O₄/Fe₂O₃) | Perovskite | LaFeO_{3-δ} |
| | (La₂O₃) | | | |
| 14 | Magnesium oxide | Cobalt oxide (CoO/Co₃O₄) | Spinel | (Mg, Co)[Mg, Co]₂O₄ |
| | (MgO) | | | |
| 15 | Calcium oxide | Cobalt oxide (CoO/Co₃O₄) | Perovskite | CaCoO_{3-δ} |
| | (CaO) | | | |
| 16 | Strontium oxide | Cobalt oxide (CoO/Co₃O₄) | Perovskite | SrCoO_{3-δ} |
| | (SrO) | | | |
| 17 | Barium oxide | Cobalt oxide (CoO/Co₃O₄) | Perovskite | BaCoO_{3-δ} |
| | (BaO) | | | |
| 18 | Cerium oxide | Cobalt oxide (CoO/Co₃O₄) | Perovskite | CeCoO_{3-δ} |
| | (CeO₂) | | | |
| 19 | Lanthanum oxide | Cobalt oxide (CoO/Co₃O₄) | Perovskite | LaCoO_{3-δ} |
| | (La₂O₃) | | | |
| 20 | Lanthanum oxide | Nickel oxide (NiO) | Ruddlesden- | La₂NiO_{4+δ}, La₃Ni₂O_{7-δ}, |
| | (La₂O₃) | | Popper | La4Ni₃O_{10-δ} |
| 21 | Praseodymium | Nickel oxide (NiO) | Ruddlesden- | Pr₄Ni₃O_{10-δ} |
| | oxide (Pr₂O₃) | | Popper | |
| 22 | Neodymium oxide | Nickel oxide (NiO) | Ruddlesden- | Nd₂NiO_{4+δ}, |
| | (Nd₂O₃) | | Popper | Nd₄Ni₃O_{10-δ} |

In another aspect, the mixed metal is produced from three or more metal oxides. For example, the mixed metal oxide can be strontium magnesium manganite (SrMno.9Mg0.103-5) or barium strontium cobalt ferrite (Ba_{0.5}Sr_{0.5}Co_{0.1} Fe_{0.9}O₃₋₆₇).

In one aspect, the mixed metal oxides have desirably high energetic efficiencies via high operating temperatures, low cost, fast reaction kinetics, and the use of air as the reacting gas for discharging heat, thereby eliminating the need for gas storage-and-management systems. In another aspect, the mixed metal oxides do not require very low partial pressures of oxygen to achieve high energy densities, making use of the mixed metal oxides described herein practical for large-scale operation.

In one aspect, the mixed metal oxides described herein have a high degree of reactive stability under high-temperature cycling, such as between 1,000° C. and 1,500° C., and optionally between 1200° C. and 1500° C. In another aspect, the metal oxides described herein can undergo phase change reactions at high operating temperatures, such as at least about 1,000° C., optionally at least about 1,100° C., optionally at least about 1,200° C., optionally at least about 1,300° C., optionally at least about 1,400° C., optionally at least about 1,500° C., and preferably at least about 1,600° C.

In another aspect, the mixed metal oxides described herein can have volumetric energy densities of at least about 1,000 MJ m⁻³ to about 3,000 MJ m⁻³, or about 1,000 MJ m⁻³, 1,250 MJ m⁻³, 1,500 MJ m⁻³, 1,750 MJ m⁻³, 2,000 MJ m⁻³, 2,250 MJ m⁻³, 2,500 MJ m⁻³, 2,750 MJ m⁻³, or 3,000 MJ m⁻³, where any value can be a lower and upper endpoint of a range (e.g., 1,750 MJ m⁻³ to 2,250 MJ m⁻³).

In another aspect, the mixed metal oxides described herein can have specific energy density of at least about 900 kJ kg⁻¹ to about 3,000 kJ kg⁻¹, or about 900 kJ kg⁻¹, 1,000 kJ kg⁻¹, 1,250 kJ kg⁻¹, 1,500 kJ kg⁻¹, 1,750 kJ kg⁻¹, 2,000 kJ kg⁻¹, 2,250 kJ kg⁻¹, 2,500 kJ kg⁻¹, 2,750 kJ kg⁻¹, or 3,000 kJ kg⁻¹, where any value can be a lower and upper endpoint of a range (e.g., 1,750 kJ kg⁻¹ to 2,500 kJ kg^{-1).}

In certain aspects, the mixed metal oxide further includes a dopant In one aspect, a dopant can raise the plasticity of the mixed metal oxide. For example, alkali metals such as Li, Na and K lowers the melting point of the mixed metal oxide and marginally lower the reduction temperature. Small quantities of Li and Na can also improve the oxidation kinetics of the mixed metal oxide. Li and Na may also be beneficial if required charge rate is low but the required discharge rate is high.

In another aspect, transition metal dopants can affect the electrical resistivity of the mixed metal oxide. In one aspect, Fe can increase the resistivity whereas Ni lowers the resistivity. Effect of ceramic oxide forming transition and rare earth metals (Ti, Zr, Hf, Sc, Al, La, Ce, etc.) can alter the resistivity of mixed metal oxides. Al increases the resistivity of MgMnO and other elements are expected to lower the resistivity. In one aspect, the dopant is selected from the group consisting of aluminum oxide (Al₂O₃—up to 10 mole %), titanium oxide (TiO₂—up to mole 10%), zirconium oxide (ZrO₂—up to mole 5%), scandium oxide (Sc₂O₃—up to 10 mole %), hafnium oxide (HfO₂—up to 5 mole %), gadolinium oxide (Gd₂O₃—up to mole 10%),, zinc oxide (ZnO—up to mole 5%), tin dioxide (SnO₂ —up to mole 5%), copper oxide (Cu₂O, CuO—up to mole 10%), strontium oxide (SrO—up to mole 20%), lithium oxide (Li₂O—up to mole 3%), and any combination thereof.

In other aspects, alkaline earth metals such as Ca, Ba, Sr can be added in small quantities to lower the electrical resistivity of the mixed metal oxide. Larger concentrations of these alkaline earth metals may lead to formation of perovskite phase, which has faster oxidation kinetics, but needs lower oxygen partial pressure for thermal reduction.

The amount of dopant used can vary depending upon the selection of the dopant and the desired property to be modified. In one aspect, the dopant is from about 0.1 weight percent to about 5 weight percent of the mixed metal oxide, or about 0.1 weight percent, 0.5 weight percent, 1.0 weight percent, 1.5 weight percent, 2.0 weight percent, 2.5 weight percent, 3.0 weight percent, 3.5 weight percent, 4.0 weight percent, 4.5 weight percent, or 5.0 weight percent, where any value can be a lower and upper endpoint of a range (e.g., 1.5 weight percent to 3.0 weight percent).

In one aspect, the mixed metal oxide can include impurities such as, for example, aluminum oxide (0.1 mass percent to less than 25 mass percent) and iron oxide (0.1 mass percent to less than 10 mass percent). Additional impurities can include calcium oxide and silicon dioxide. In one aspect, the mixed metal oxide consists essentially of the mixed metal oxide and one or more impurities such as aluminum oxide, iron oxide, calcium oxide, silicon dioxide, or any combination thereof.

### Configuration of Energy Storage Article

The energy storage articles described herein are three-dimensional structures. The articles are not beads or pellets typically used in packed-bed energy storage systems. The energy storage articles described herein provide numerous electrical and mechanical advantages over beads or pellets, including but not limited to, (1) more constant electrical properties over longer timespans, (2) more predictable electrical properties, (3) greater ease of building tortuous electrical pathways that allow for tailored electrical resistance, (4) greater ease of containing the articles described herein relative to pellets, since the induced stress due to the weight of the three-dimensional structures is only in the direction of gravity, (5) microscopically and macroscopically more uniform electrical current distribution and less risk of melting, (6) higher effective thermal conductivity, (7) less contact resistance avoids local overheating and melting, (8) lower resistance to fluid flow compared to packed beds, (9) greater ease of accommodating differences in thermal expansion between the storage articles and refractory assemblies, (10) energy storage articles have a higher apparent density compared to packed beds of pellets, leading to higher potential volumetric energy density and (11) better mechanical stability and less sagging.

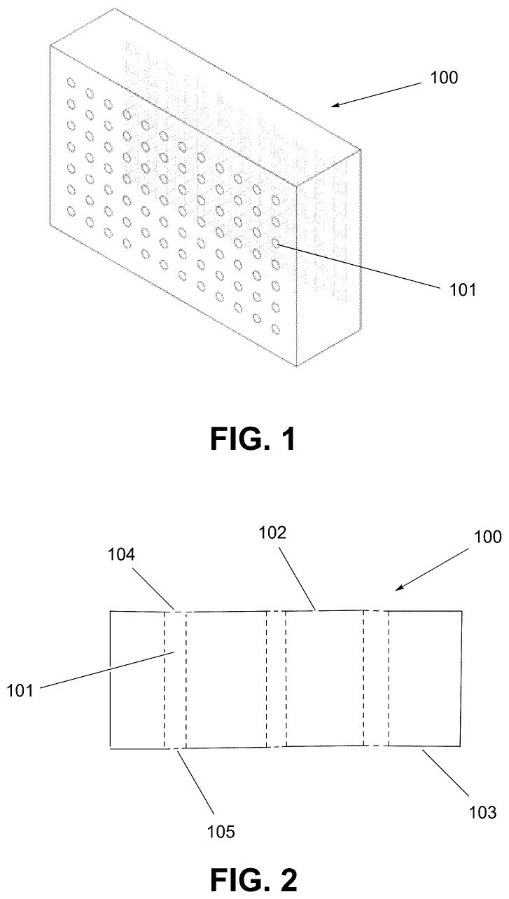

The energy storage articles can be manufactured in a variety of different configurations to maximize the efficiency of the energy storage and production. In one aspect, the energy storage article is a brick. The geometry of the brick can vary, which can include a cube, a trapezoidal prism, a hexagonal prism, an octagonal prism, and a rectangular prism. FIGS. 1 and 2 depict the brick as a rectangular prism.

Referring to FIG. 1, the brick 100 has a plurality of gas passages 101. FIG. 2 is a crosse-sectional view of the brick 100. Referring to FIG. 2, the brick includes at least one pair of parallel surfaces comprising a first surface 102 and a second surface 103, wherein a plurality of gas passages 101 extends from the first surface to the second surface, and wherein each gas passage has a first gas passage opening 104 and a second gas passage opening 105.

The gas passage 101 depicted in FIGS. 1 and 2 are cylindrical; however, the gas passage can be other shapes including square, hexagonal, rectangular, star-shaped, and shapes that maximize the internal surface area of the passage, and any combination thereof. In one aspect, the gas passage 101 has a hydraulic diameter of from about 3 mm to about 10 mm, or about 3 mm, 4 mm, 5 mm, 6 mm, 7 mm, 8 mm, 9 mm, or 10 mm, where any value can be a lower and upper endpoint of a range (e.g., 4 mm to 7 mm).

The spacing of the plurality of the gas passages 101 can vary. In one aspect, the plurality of the gas passages 101 are symmetrically and evenly spaced from one another as depicted in FIG. 1. The spacing between each gas passage can vary as well. In one aspect, the spacing between each gas passage is the same as measured from the center of each gas passage. In one aspect, each gas passage is spaced from one another at about 8 mm to about 25 mm, or about 8 mm, 10 mm, 12 mm, 14 mm, 16 mm, 18 mm, 20 mm, 22 mm, 24 mm, or 25 mm, where any value can be a lower and upper endpoint of a range (e.g., 10 mm to 16 mm).

In one aspect, when the brick is a rectangular prism as depicted in FIGS. 1 and 2, the prism has a length of about 100 mm to about 300 mm, a width of about 80 mm to about 200 mm, and a height of about 25 mm to about 80 mm.

In another aspect, the brick has a geometrical surface to volume ratio between about 0.02/mm to about 2.0/mm, or 0.02/mm, 0.05/mm, 0.10/mm, 0.20/mm, 0.40/mm, 0.60/mm, 0.80/mm, 1.20/mm, 1.40/mm, 1.60/mm, 1.80/mm, or 2.0/mm, where any value can be a lower and upper endpoint of a range (e.g., 0.05/mm to 1.40/mm). The geometrical surface to volume ratio, SV, defined by the sum of all surface areas, Aₛ, divided by the enclosed solid volume, Vₛ includes the surface of the gas passages, the outside surfaces, as well as the surface of any surface features (SV=ΣₛAₛ/Vₛ).

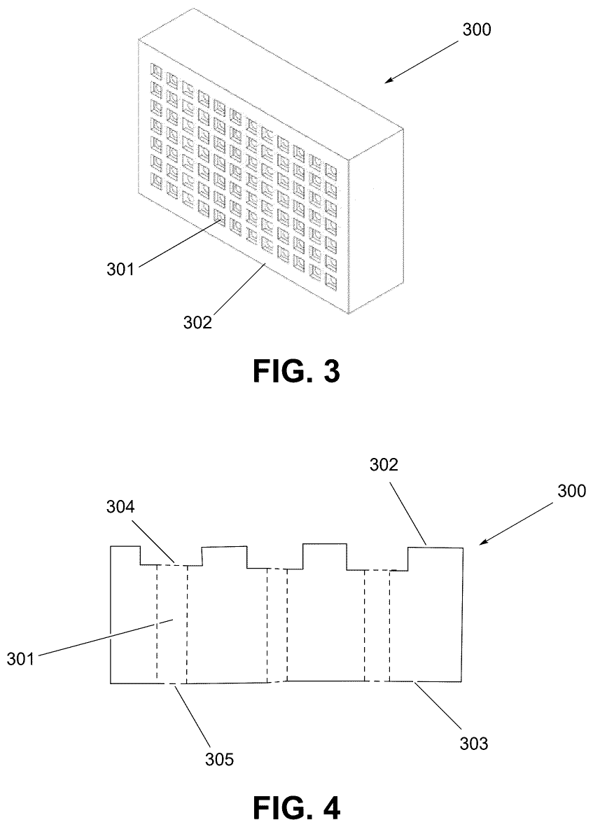

In one aspect, each first gas passage opening is recessed on the first surface of the of brick and/or each second gas passage opening is recessed on the second surface of the of brick. Referring to FIGS. 3 and 4, first gas passage opening 301 is recessed on the first surface 302 of the of brick 300. FIG. 4 depicts only recessed first gas passage openings 301 on the first surface 302; however, second gas passage openings 304 can also be recessed on the second surface 303 of the of brick 300. Recessed openings allow for good gas permeability (open flow paths) even if gas passages do not perfectly overlap between successive bricks.

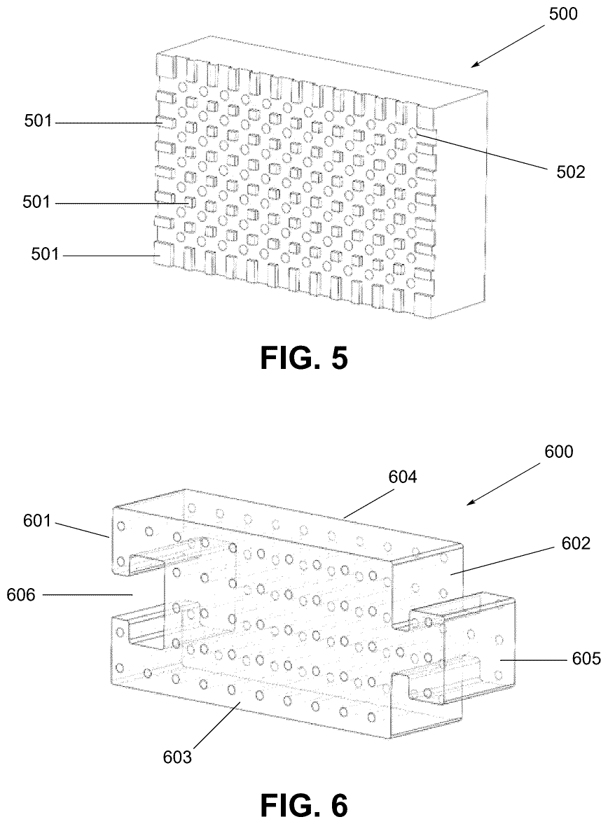

In another aspect, the first surface and/or the second surface of the brick can include one or more raised members. One aspect is depicted in FIG. 5, where the brick 500 has a plurality of raised members 501 and gas passages 502. Similar to the recessed gas passages as depicted in FIGS. 3 and 4, raised members allow for good gas permeability of brick assemblies.

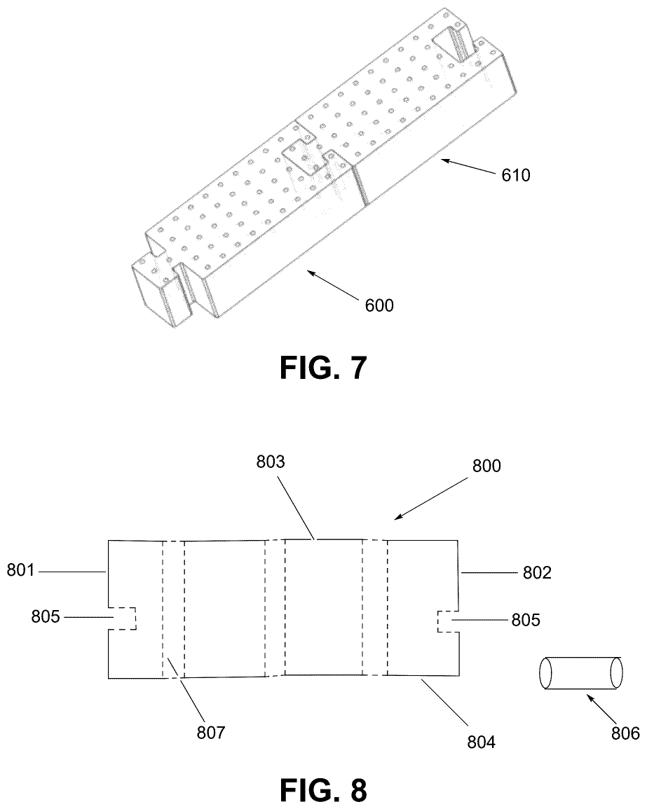

In another aspect, the brick has a second pair of parallel surfaces comprising a third surface and a fourth surface, wherein the third surface and the fourth surface are perpendicular to the first surface and the second surface, and wherein the third surface comprises a locking member and the fourth surface comprises a receiving member for receiving a locking member from a second brick. Referring to FIG. 6, the brick 600 has a third surface 601 and a fourth surface 602 that are perpendicular to the first surface 603 and the second surface 604. A locking member 605 and a receiving member 606 for receiving a locking member 605 from a second brick 610 as depicted in FIG. 7. The interlocking features increase the mechanical stability of brick assemblies.

In another aspect, the brick has a second pair of parallel surfaces comprising a third surface and a fourth surface, wherein the third surface and the fourth surface are perpendicular to the first surface and the second surface, and wherein third surface, the fourth surface, or a combination thereof has an opening for receiving a locking member. Referring to FIG. 8, brick 800, the third surface 801 and the fourth surface 802 are perpendicular to the first surface 803 and the second surface 804, and where third surface, the fourth surface, or a combination thereof has an opening 805 for receiving a locking member. Here, the dowel can be inserted in opening 805 in two different bricks to mechanically connects the bricks. In one aspect, the opening 805 does not extend into gas passage 807.

In one aspect, the locking member is a dowel, which is depicted as 806 in FIG. 8. In one aspect, the dowel is composed of a refractory material. In another aspect, the dowel includes a second mixed metal oxide, wherein the second mixed metal oxide is the same or different mixed metal oxide in the brick.

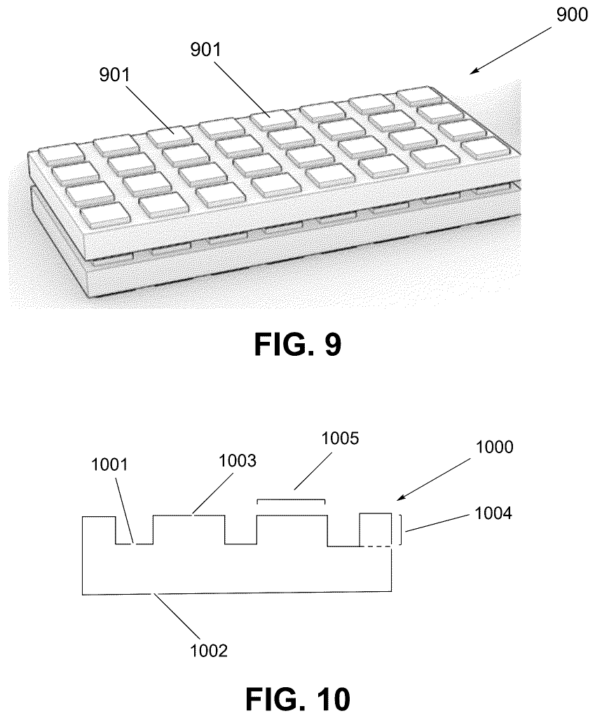

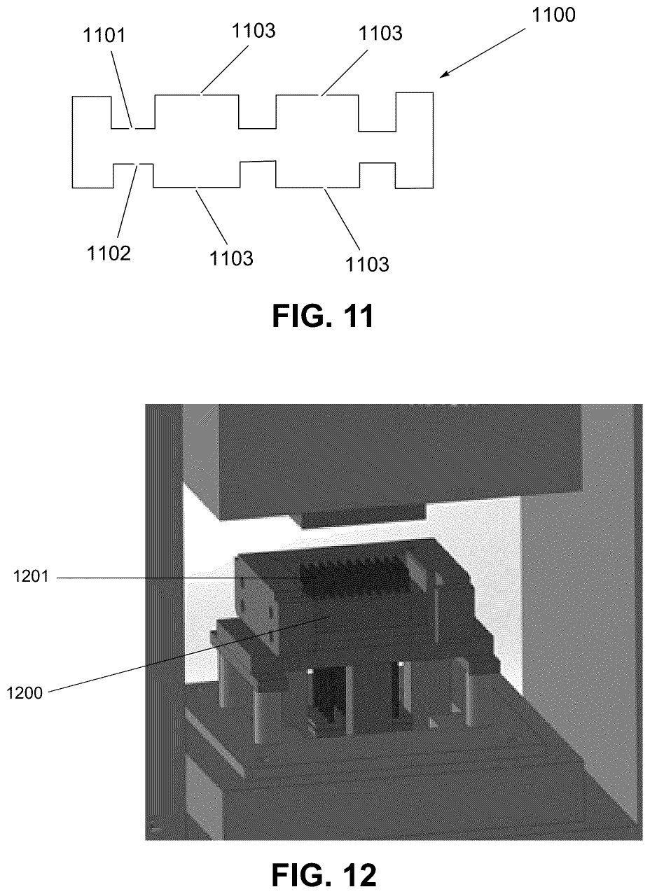

In another aspect, the energy storage article is a tile. FIGS. 9-11 depict a tile as described herein. Referring to FIG. 9, tile 900 has a plurality of raised members 901. FIGS. 10 and 11 are cross-sectional views of the tile with raised members. Referring to FIG. 10, tile 1000 has a first surface 1001 and a second surface 1002, wherein the first surface includes a plurality of raised members. Referring to FIG. 11, tile 1100 has a first surface 1101 and a second surface 1002, wherein the first surface and second surface includes a plurality of raised members. In one aspect, the tile is formed by molding the mixed metal oxide, where the tile with raised members is formed of the same mixed metal oxide.

In one aspect, when the tile has a length of about 100 mm to about 400 mm, a width of about 80 mm to about 200 mm, and a height of about 10 mm to about 50 mm. In another aspect, the ratio of the length/width ratio of the is from 1:1 to 4:1, 1.5:1 to 3:1, or 2:1.

The dimensions of the raised members in the tile can vary. As discussed in further detail below, stacking several tiles on top of each other yields a perforated stack, where the holes created by the stacked tiles produces gas passages that have similar hydraulic characteristics as the stack of bricks described herein. The shape of the raised members can vary in geometrical shape such as, for example, squares, rectangles, or circles. Referring to FIG. 9, the raised members 901 are in the shapes of squares. In another aspect, the raised members are configured in a symmetrical formation as depicted in FIG. 9.

In one aspect, referring to FIG. 10, the raised members 1003 have a height 1004 from about 2 mm to about 7 mm, a width 1005 from about 5 mm to about 50 mm, and a length from about 5 mm to about 50 mm. In another aspect the raised members can extend from one side of the tile to the opposing side whereas their height ranges from about 2 mm to 6 mm with a width ranging from 5 mm to 50 mm.

The spacing of the plurality of raised members in the tile can vary. In one aspect, the plurality of the raised members are symmetrically and evenly spaced from one another as depicted in FIG. 9. In one aspect, each raised member is spaced from one another at about 8 mm to about 25 mm from the center of each raised member, or about 8 mm, 10 mm, 12 mm, 14 mm, 16 mm, 18mm, 20 mm, 22 mm, 24 mm, or 25 mm, where any value can be a lower and upper endpoint of a range (e.g., 10 mm to 16 mm).

In one aspect, the tile can include a locking member and a receiving member for receiving a locking member from a second tile. The configuration as depicted in FIGS. 6 and 7 for interlocking the bricks described herein can also be applied to the tiles as well.

In another aspect, the tile has can have one or more openings for receiving a locking member. In one aspect, a dowel can be inserted in opening in two different tiles to mechanically connects the tiles in the same manner as depicted in FIG. 8. In one aspect, the dowel is composed of a refractory material. In another aspect, the dowel includes a second mixed metal oxide, wherein the second mixed metal oxide is the same or different mixed metal oxide in the tile.

### Preparation of Energy Storage Articles

In one aspect, the energy storage articles described herein can be produced by a variety methods to vary the shape, configurations, and geometry of the energy storage article.

In one aspect, prior to forming the energy storage article, the mixed metal oxide can be ground or granulated to produce particles or granules of a desired size. In one aspect, the mixed metal oxide is granulated so that the granules have an average particle size of about 0.1 mm to about 1.0 mm, or about 0.1 mm, 0.2 mm, 0.3 mm, 0.4 mm, 0.5 mm, 0.6 mm, 0.7 mm, 0.8 mm, 0.9 mm, or 1.0 mm, where any value can be a lower and upper endpoint of a range (e.g., 0.3 mm to 0.7 mm).

When preparing the granulated powder, one or more additional components can be added to the mixed metal oxide prior to introduction into the mold or die in order to improve performance of the energy storage article. In one aspect, a mechanical support phase can be added to the mixed metal oxide. In one aspect, the mechanical support phase is gravel. In one aspect, the gravel is composed of a metal oxide including, but not limited to, magnesium oxide, aluminum oxide, naturally occurring corundum, zirconium oxide, yttrium oxide, or any combination thereof.

The particle size and amount of the gravel can vary depending upon the desired mechanical properties. In one aspect, the gravel has an average particle size of from about 0.1 mm to about 7 mm, or about 0.1 mm, 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, or 7.0 mm, where any value can be a lower and upper endpoint of a range (e.g., 1.5 mm to 5.0 mm). In another aspect, the gravel is from about 5 volume percent to about 50 volume percent of the energy storage article, or 5 volume percent, 10 volume percent, 20 volume percent, 30 volume percent, 40 volume percent, or 50 volume percent, where any value can be a lower and upper endpoint of a range (e.g., 10 volume percent to 30 volume percent).

In one aspect, the mechanical support phase is ceramic fibers. In one aspect, the ceramic fibers include, but are not limited to, alumina, magnesium oxide, magnesium aluminate, zirconium oxide, cerium oxide, lanthanum oxide, cerium aluminate, lanthanum aluminate, titanium oxide, calcium titanate, strontium titanate, calcium zirconate, strontium zirconate, or barium zirconate. In another aspect, the ceramic fibers are from about 1 volume percent to about 50 volume percent of the energy storage article, or 1 volume percent, 5 volume percent, 10 volume percent, 20 volume percent, 30 volume percent, 40 volume percent, or 50 volume percent, where any value can be a lower and upper endpoint of a range (e.g., 10 volume percent to 30 volume percent).

In another aspect, a binder can be added to the mixed metal oxide prior to the formation of the energy storage article. In one aspect, the binder includes, but is not limited to, the binder is polyvinyl alcohol, polyethylene glycol, polyvinyl butyral, hydroxypropyl methylcellulose, carboxymethylcellulose, starch, dextrin, ammonium polyacrylate, a lignosulfonate, or any combination thereof. In another aspect, the binder is from about 0.1 weight percent to about 5 weight percent of the relative to the amount of the mixed metal oxide, or is about 0.1 weight percent, 0.5 weight percent, 1.0 weight percent, 1.5 weight percent, 2.0 weight percent, 2.5 weight percent, 3.0 weight percent, 3.5 weight percent, 4.0 weight percent, or 5.0 weight percent, where any value can be a lower and upper endpoint of a range (e.g., 1.5 weight percent to 3.0 weight percent).

In one aspect, when the energy storage article is a brick as described herein, the brick is produced by the method comprising
dry pressing a mixed metal oxide in a die comprising a plurality of rods to produce a pressed structure, wherein the mixed metal oxide is (i) reduced when heated to produce a reduced state and (ii) when in the reduced state, the mixed metal oxide is oxidized when exposed to an oxygenated gas; and heating the pressed structure to produce the brick.

FIG. 12 provides an exemplary mold configuration for producing bricks described herein. The mold 1200 includes a plurality of circular rods as depicted in FIG. 12, which will ultimately produce cylindrical gas passages in the brick; however, the rods can be other geometrical shapes including squares or rectangles.

In one aspect, the mixed metal oxide is introduced into the mold as a dry granulated powder. After the mixed metal oxide is introduced into the mold, the mixed metal oxide is dry pressed. In one aspect, the mixed metal oxide is dry pressed at a pressure of about 5 MPa to about 500 Mpa, or about 5 Mpa, 10 Mpa, 50 Mpa, 100 Mpa, 150 Mpa, 200 Mpa, 250 Mpa, 300 Mpa, 350 Mpa, 400 Mpa, 450 Mpa, or 500 Mpa, where any value can be a lower and upper endpoint of a range (e.g., 100 MPa to 300 MPa). The pressed green body is ejected from the mold. In one aspect, a Separating agent can be applied to the mold prior to the introduction of the mixed metal oxide into the mold. Separating agents may include, but are not limited to, graphite powder, vegetable oils, mineral oils, lubricants, metal oxide powders, or combinations thereof.

After dry pressing, the pressed structure (i.e., green body) is removed from the mold and subsequently heated up to a temperature less than or equal to 1,600° C. The heating schedule can vary. For example, the pressed structure can be heated from 50° C. to 200° C. per hour up to 1,600° C. In other aspects, heating of the pressed structure can be heated in sequential stages. For example, the pressed structure can be first be heated to a first temperature then cooled down and subsequently heated at a second temperature and subsequently cooled down. There can be hold times where the pressed structure is held at one or more temperatures for some period of time. The duration of heating can vary depending upon the heating schedule. In one aspect, the pressed structure is heated from about 0.1 hour to about 72 hours. The Examples provide non-limiting procedures for producing the bricks described herein.

In the case when the energy storage article is a tile as described herein, the mixed metal oxide can be dry pressed in a mold, where the mold is configured to produce a plurality of raised members on the first surface and/or second surface of the tile. The dry pressing and heating conditions described above for producing the bricks described herein can also be used to produce the tiles described herein.

In another aspect, the bricks and tiles described herein can be produced by extrusion. For example, a paste comprising the mixed metal oxide with one or more optional components (e.g., plasticizers, binders, etc.) can be extruded through a die with a specified configuration to produce the bricks or tiles. The resulting extruded product can subsequently heated as described above.

In another aspect, the bricks and tiles described herein can be produced by casting. For example, a solution comprising the mixed metal oxide with one or more optional components (e.g., plasticizers, binders) can be introduced into a mold with a specified configuration to produce the bricks or tiles. The resulting solidified product can be subsequently removed from the mold heated as described above.

### Applications of the Energy Storage Articles

The energy storage articles described herein can be incorporated into a thermochemical energy storage device that stores and releases energy. In one aspect, the thermochemical energy storage device is composed of
a vessel defining an interior volume, the vessel comprising at least one inlet and at least one outlet; and
a plurality of the energy storage articles (e.g., bricks or tiles) described herein disposed within the interior volume and in fluid communication with the inlet and the outlet.

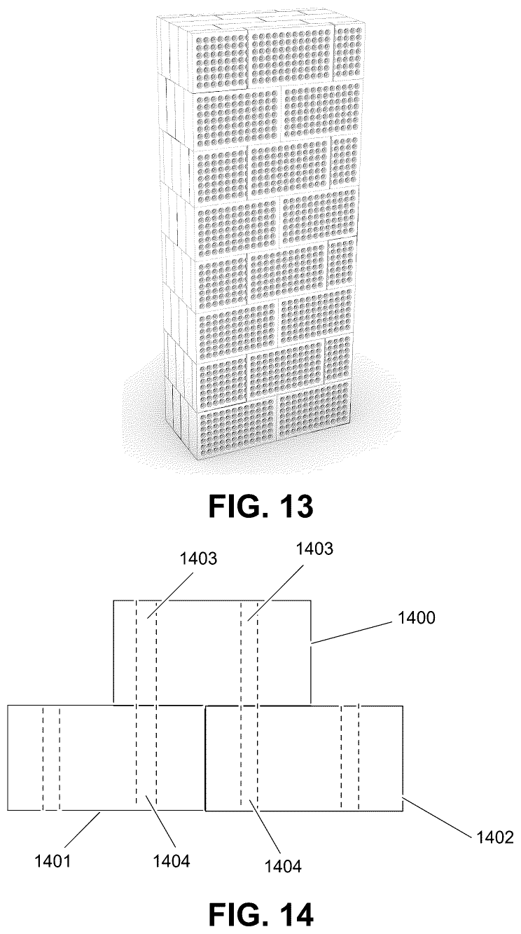

In one aspect, when the energy storage article is a brick, a plurality of bricks can be stacked to form a tower as depicted in FIG. 13. In one aspect, a plurality of bricks is disposed within the interior volume of the vessel so that at least one gas passage of each brick overlaps with at least one gas passage of an adjacent brick. This feature is depicted in FIG. 14, where the bricks 1400, 1401, and 1402 are configured in a staggered formation, where gas passages 1403 of brick 1400 are aligned with gas passages 1404 of bricks 1401 and 1402.

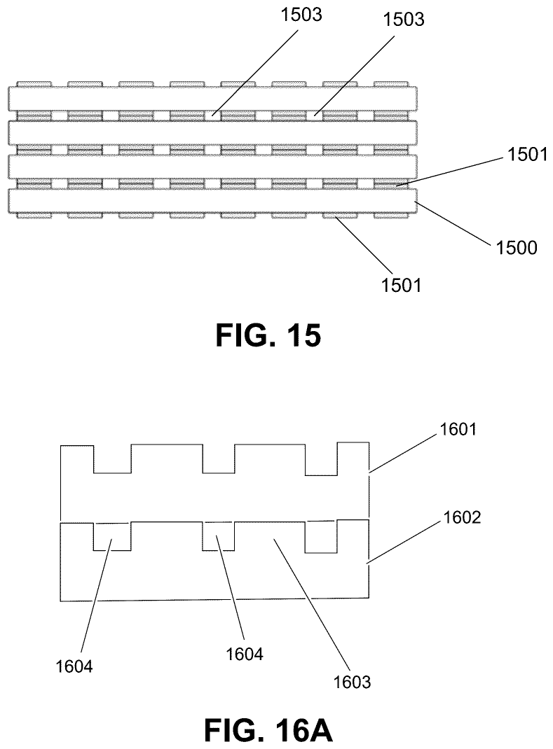

In another aspect, a plurality of tiles is disposed within the interior volume of the vessel so that a plurality of gas passages is produced. One aspect of this is depicted in FIG. 15, where each 1500 has a plurality of raised members 1501 on each side (i.e., first and second side) of the tile. As shown in FIG. 15, the raised members of each tile are aligned with one another, which ultimately produces a plurality of gas passages 1503.

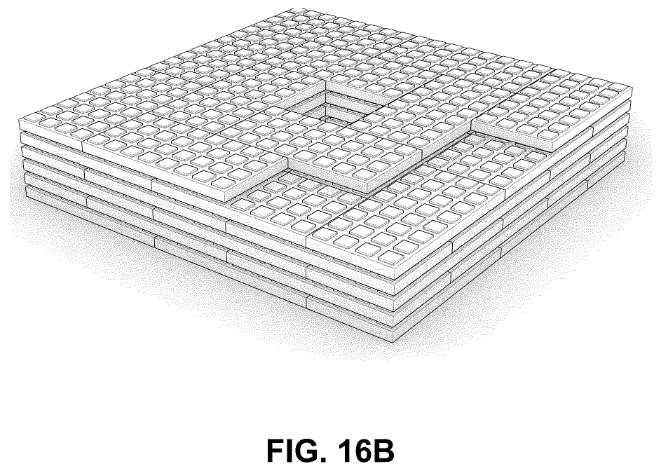

FIGS. 16A and 16B depict another aspect for stacking tiles described herein. Referring to FIG. 16A, tiles 1601 and 1602 each have a flat surface (i.e., no raised members). When stacked as depicted in FIG. 16A, the raised members 1603 of tile 1602 form a plurality of gas passages 1604 when stacked with surface of tile 1601 that does not include raised members. FIG. 16B shows the tiles stacked in a three dimensional configuration.

The number of energy storage articles described herein (e.g., bricks or tiles) disposed in the vessel can vary depending upon the amount of energy storage and product that is needed. In certain aspects, a paste or powder comprising a second mixed metal oxide is disposed between each energy storage article. In one aspect, the second mixed metal oxide is the same or different mixed metal oxide present in the energy storage article. In another aspect, the second mixed metal oxide is an electroconductive material. In one aspect, when the energy storage article is a brick, the paste or powder is applied to each energy storage article so that it does not cover any gas passage openings in the bricks.

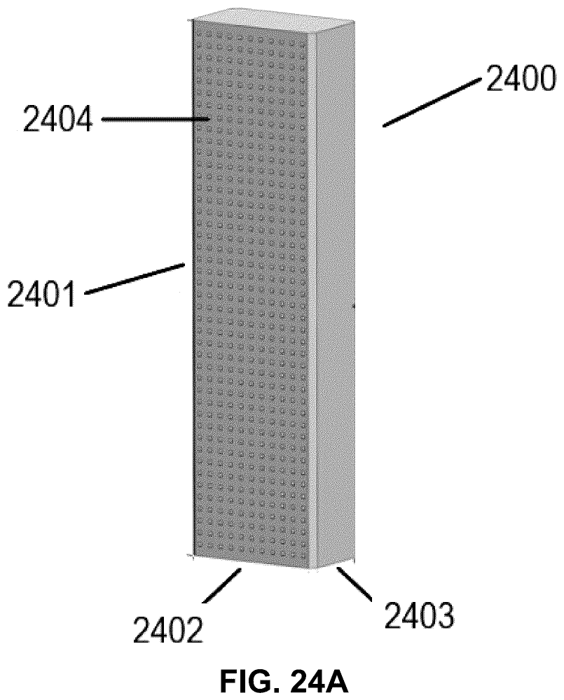

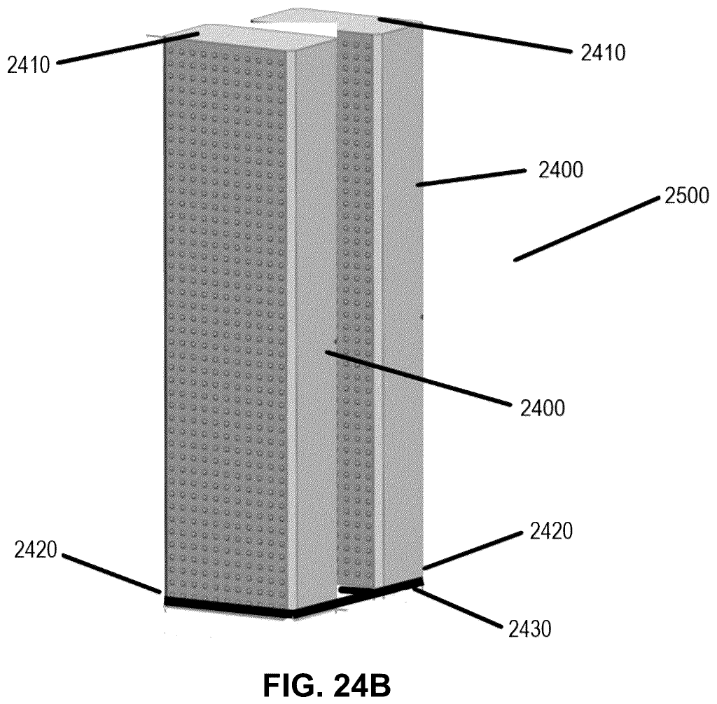

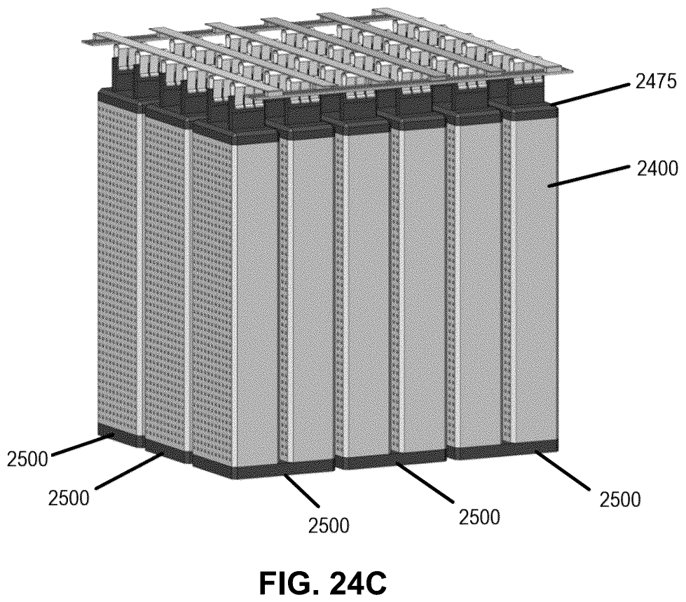

In one aspect, the bricks or tiles described can be assembled to produce a monolith. An example of a monolith useful herein is provided in FIG. 24A. Referring to FIG. 24A, the monolith 2400 is in the shape of a rectangular prism; however, other geometric shapes can be used. The dimensions of the monolith can vary depending upon the application of the thermochemical energy storage device. In one aspect, the monolith can have a height 2401 of about 1 meter to about 5 meters, a width 2402 of about 0.1 meters to about 2 meters, and a depth 2403 of about 0.1 meters to about 2 meters. The monolith can include a plurality of channels 2404 that traverse from one side of the monolith to the other side similar to the bricks described above.

In one aspect, the monolith can be composed of multiple blocks or tiles that are subsequently bonded to one another to produce the monolith. In one aspect, the bricks or tiles are stacked with one another to produce a 3-dimensional structure and subsequently heated at a sufficient temperature to fusion bond the bricks or tiles to one another. In another aspect, a paste or powder comprising a second mixed metal oxide that is the same or different mixed metal oxide present in the brick or tile can be used to bond the bricks or tiles together. The paste or powder is applied to the bricks so that it does not cover any gas passage openings in the bricks. The bricks or tiles once assembled can be subsequently heated to soften the paste or powder and produce the monolith.

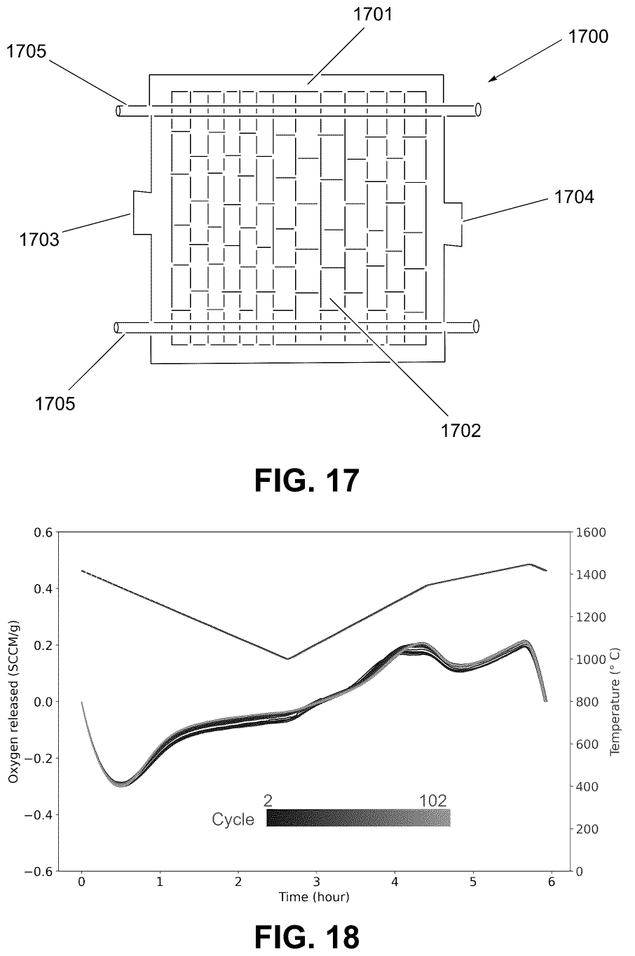

FIG. 17 shows the cross-section of the thermochemical energy storage device 1700. Within the vessel 1701, a plurality of energy storage articles 1702 are stacked within the vessel. The inlet 1703 and outlet 1704 can be positioned such that oxygenated gas can readily enter the vessel and come into contact with the energy storage articles followed by exiting the vessel through outlet 1704.

In one aspect, one or more electrodes 1705 are present and in contact with the plurality of energy storage articles as depicted in FIG. 17. In this aspect, electricity delivered by the electrodes is converted to heat to cause the mixed metal oxide to be reduced in an endothermic reaction.

In one aspect, the mixed metal oxide in the energy storage articles is heated to a reduction temperature of at least about 1,000° C., at least about 1,100° C., at least about 1,200° C., at least about 1,300° C., at least about 1,400° C., at least about 1,500° C., or at least about 1,600° C.

In one aspect, the thermochemical energy storage device includes two or more monoliths as the energy storage material. Referring to FIG. 24B, each monolith 2400 has a first end 2410 and a second end 2420. A high-temperature electrically conductive ceramic plate 2430 connects at least two of the monoliths, where the ceramic plate 2430 is in contact with the second end 2420 of each monolith. As referred to herein two or more monoliths connected to one another by the high-temperature electrically conductive ceramic plate 2430 is referred to as a cell 2500 as depicted in FIG. 25B.

A plurality of cells can be assembled and placed into the vessel of the thermochemical energy storage device. FIG. 24C depicts an assembly of a plurality of cells 2500 to be used in the thermochemical energy storage device. Each monolith 2400 has an electrode 2475 in contact with the first end 2410 of each monolith. Any of the electrodes described herein can be attached to the first end of the monolith. The number of cells can vary depending upon the application of the thermochemical energy storage device.

When the mixed metal oxide is heated to at least the reduction temperature, the mixed metal oxide is chemically reduced to generate oxygen. In one aspect, a blower delivers air to the reactive metal oxide, and the oxygen is swept away by air. In one aspect, a blower is fluidly connected to the outlet, and the suction side of the blower pulls oxygen out of the metal oxide. The evolved oxygen may be collected, such as for sale or use in other processes. In one aspect, an inert sweep gas may be circulated through the interior volume of the vessel with the energy storage articles. The use of an inert sweep gas may further improve energy density.

When the mixed metal oxide in the energy storage articles is in the reduced state, it is reactive to oxygen. The reaction is highly exothermic, which releases energy from the mixed metal oxide in the form of heat. The method involves providing oxygenated gas into the vessel of the thermochemical energy storage device. In one aspect, the oxygenated gas can be introduced into the thermochemical energy storage device through the inlet via a compressor, blower, or pump. During energy release, heated air or gas can be fluidly connected to a turbine. The turbine can subsequently expand the heated air or gas produced from the energy storage articles present in the thermochemical energy storage device when the mixed metal oxide in the reduced state is contacted with air or oxygenated gas. The expanded heated air or gas through the turbine can power a generator, which ultimately generates electricity.

In another aspect, during energy release, the heated air or gas can be fluidly connected to a range of industrial devices that require or use heat. For example, the heat produced can be used in industrial heating applications including, but not limited to, heating a boiler or steam generator, heating a metal melting furnace, heating a metal alloying furnace, heating a kiln or calciner, heating food processing furnace, heating extractive metallurgy furnaces, heating industrial heat transfer oil, heating pre-calciners, heating asphalt, heating a drying furnace.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Aspects

The present disclosure can be described in accordance with the following numbered Aspects, which should not be confused with the claims.

### Aspect 1. A brick comprising

a mixed metal oxide, wherein the mixed metal oxide (i) is reduced when heated to produce a reduced state and (ii) when in the reduced state, the mixed metal oxide is oxidized when exposed to an oxygenated gas, and the mixed metal oxide is electrically conductive; and
the brick comprises at least one pair of parallel surfaces comprising a first surface and a second surface, wherein a plurality of gas passages extends from the first surface to the second surface, and wherein each gas passage has a first gas passage opening and a second gas passage opening.

Aspect 2. The brick of Aspect 1, wherein the mixed metal oxide comprises the reaction product between manganese oxide and a metal oxide selected from the group consisting of magnesium oxide, calcium oxide, strontium oxide, barium oxide, yttrium oxide, cerium oxide, lanthanum oxide, and any combination thereof when heated in the presence of oxygen.

Aspect 3. The brick of Aspect 2, wherein manganese oxide is MnO, Mn₃O₄, Mn₂O₃, MnO₂, or any combination thereof.

Aspect 4. The brick of Aspect 1, wherein the mixed metal oxide comprises the reaction product between iron oxide and a metal oxide selected from the group consisting of magnesium oxide, calcium oxide, strontium oxide, barium oxide, cerium oxide, lanthanum oxide, and any combination thereof when heated in the presence of oxygen.

Aspect 5. The brick of Aspect 4, wherein iron oxide is FeO, Fe₃O₄, Fe₂O₃, or any combination thereof.

Aspect 6. The brick of Aspect 1, wherein the mixed metal oxide comprises the reaction product between cobalt oxide and a metal oxide selected from the group consisting of magnesium oxide, calcium oxide, strontium oxide, barium oxide, cerium oxide, lanthanum oxide, and any combination thereof when heated in the presence of oxygen.

Aspect 7. The brick of Aspect 6, wherein cobalt oxide is CoO, Co₃O₄, or any combination thereof.

Aspect 8. The brick of Aspect 1, wherein the mixed metal oxide comprises the reaction product between nickel oxide and a metal oxide selected from the group consisting of lanthanum oxide, praseodymium oxide, neodymium oxide, and any combination thereof when heated in the presence of oxygen.

Aspect 9. The brick of Aspect 1, wherein the mixed metal oxide comprises the reaction product between manganese oxide and magnesium oxide when heated in the presence of oxygen.

Aspect 10. The brick of any one of Aspects 1-9, wherein the mixed metal oxide further comprises a dopant.

Aspect 11. The brick of Aspect 10, wherein the dopant is selected from the group consisting of aluminum oxide (Al₂O₃), titanium oxide (TiO₂), zirconium oxide (ZrO₂), scandium oxide (Sc₂O₃), hafnium oxide (HfO₂), gadolinium oxide (Gd₂O₃), tantalum oxide (Ta₂O₃), zinc oxide (ZnO), tin dioxide (SnO₂), copper oxide (Cu₂O, CuO), strontium oxide (SrO), lithium oxide (Li₂O), and any combination thereof.

Aspect 12. The brick of any one of Aspects 1-11, wherein the oxygenated gas comprises air.

Aspect 13. The brick of any one of Aspects 1-12, wherein the brick has a geometry selected from the group consisting of a cube, a trapezoidal prism, a hexagonal prism, an octagonal prism, and a rectangular prism.

Aspect 14. The brick of any one of Aspects 1-12, wherein the brick is a rectangular prism, wherein the prism has a length of about 100 mm to about 300 mm, a width of about 80 mm to about 200 mm, and a height of about 25 mm to about 80 mm.

Aspect 15. The brick of any one of Aspects 1-14, wherein the gas passage has a shape selected from the group consisting of round, square, hexagonal, rectangular, and any combination thereof.

Aspect 16. The brick of any one of Aspects 1-15, wherein the gas passage has a hydraulic diameter of from about 3 mm to about 10 mm.

Aspect 17. The brick of any one of Aspects 1-16, wherein each gas passage is spaced from one another at about 8 mm to about 25 mm.

Aspect 18. The brick of any one of Aspects 1-17, the brick has a geometrical surface to volume ratio of the brick is between about 0.02/mm to about 2.0/mm.

Aspect 19. The brick of any one of Aspects 1-18, wherein each first gas passage opening is recessed on the first surface of the brick and/or each second gas passage opening is recessed on the second surface of the brick.

Aspect 20. The brick of any one of Aspects 1-19, wherein the first surface and/or the second surface of the brick comprises one or more raised members.

Aspect 21. The brick of any one of Aspects 1-20, wherein the brick has a second pair of parallel surfaces comprising a third surface and a fourth surface, wherein the third surface and the fourth surface are perpendicular to the first surface and the second surface, and wherein the third surface comprises a locking member and the fourth surface comprises a receiving member for receiving a locking member from a second brick.

Aspect 22. The brick of any one of Aspects 1-20, wherein the brick has a second pair of parallel surfaces comprising a third surface and a fourth surface, wherein the third surface and the fourth surface are perpendicular to the first surface and the second surface, and wherein third surface, the fourth surface, or a combination thereof has an opening for receiving a locking member.

Aspect 23. The brick of Aspect 22, wherein the locking member comprises a dowel.

Aspect 24. The brick of Aspect 23, wherein the dowel comprises a refractory material

Aspect 25. The brick of Aspect 23, wherein the dowel comprises a second mixed metal oxide, wherein the second mixed metal oxide is the same or different mixed metal oxide in the brick.

Aspect 26. The brick of any one of Aspects 1-25, wherein the brick further comprises a mechanical support phase.

Aspect 27. The brick of Aspect 26, wherein the mechanical support phase comprises gravel.

Aspect 28. The brick of Aspect 27, wherein the gravel has an average particle size of from about 0.1 mm to about 7 mm.

Aspect 29. The brick of Aspect 27 or 28, wherein the gravel comprises magnesium oxide, aluminum oxide, naturally occurring corundum, zirconium oxide, yttrium oxide, or any combination thereof.

Aspect 30. The brick of any one of Aspects 27-29, wherein the gravel is from about 5 volume percent to about 50 volume percent of the brick.

Aspect 31. The brick of Aspect 26, wherein the mechanical support phase comprises ceramic fibers.

Aspect 32. The brick of Aspect 31, wherein the ceramic fibers comprise alumina, magnesium oxide, magnesium aluminate, zirconium oxide, cerium oxide, lanthanum oxide, cerium aluminate, lanthanum aluminate, titanium oxide, calcium titanate, strontium titanate, calcium zirconate, strontium zirconate, or barium zirconate.

Aspect 33. The brick of Aspects 31 or 32, wherein the fibers are from about 1 volume percent to about 50 volume percent of the brick.

Aspect 34. The brick of any one of Aspects 1-25, wherein the mixed metal oxide consists essentially of magnesium-manganese oxide.

Aspect 35. The brick of any one of Aspects 1-25, wherein the mixed metal oxide consists of magnesium-manganese oxide.

Aspect 36. A brick or tile produced by the method comprising
(a) dry pressing a mixed metal oxide in a die comprising a plurality of rods to produce a pressed structure, wherein the mixed metal oxide is (i) reduced when heated to produce a reduced state and (ii) when in the reduced state, the mixed metal oxide is oxidized when exposed to an oxygenated gas; and
(b) heating the pressed structure to produce the brick.

Aspect 37. The brick of Aspect 36, wherein the mixed metal oxide in step (a) comprises granules having an average particle size of about 0.1 mm to about 1.0 mm.

Aspect 38. The brick of Aspect 36 or 37, wherein the mixed metal oxide in step (a) further comprises a binder.

Aspect 39. The brick of Aspect 38, wherein the binder is from about 0.1 weight percent to about 5 weight percent of the relative to the amount of mixed metal oxide.

Aspect 40. The brick of Aspect 38 or 39, wherein the binder is polyvinyl alcohol, polyethylene glycol, polyvinyl butyral, hydroxypropyl methylcellulose, carboxymethylcellulose, starch, dextrin, ammonium polyacrylate, a lignosulfonate, or any combination thereof.

Aspect 41. The brick of any one of Aspects 36-40, wherein the rods are circular, square, rectangular, or any combination thereof.

Aspect 42. The brick of any one of Aspects 36-41, wherein the mixed metal oxide is dry pressed at a pressure of about 5 MPa to about 500 MPa.

Aspect 43. The brick of any one of Aspects 36-42, wherein the pressed structure is heated up to a temperature less than or equal to 1,600° C.

Aspect 44. The brick of any one of Aspects 36-43, wherein the pressed structure is heated from about 0.1 hour to about 20 hours.

Aspect 45. The brick of any one of Aspects 36-44, wherein the mixed metal oxide consists essentially of magnesium oxide and manganese oxide.

Aspect 46. The brick of any one of Aspects 36-44, wherein the mixed metal oxide consists of magnesium oxide and manganese oxide.

Aspect 47. A tile comprising
(a) a mixed metal oxide, wherein the mixed metal oxide (i) is reduced when heated to produce a reduced state and (ii) when in the reduced state, the mixed metal oxide is oxidized when exposed to an oxygenated gas; and
(b) the tile comprises at least one pair of parallel surfaces comprising a first surface and a second surface, wherein the first surface and/or the second surface of the tile comprises a plurality of raised members.

Aspect 48. The tile of Aspect 47, wherein the tile comprises a molded article, wherein the tile with the plurality of raised members comprises the same mixed metal oxide.

Aspect 49. A monolith comprising a plurality of bricks or tiles of any one of Aspects 1-48, wherein the bricks or tiles are bonded to one another, and wherein the monolith comprises a plurality of channels that traverse from one side of the monolith to the other side of the monolith.

Aspect 50. The monolith of Aspect 49, wherein the bricks or tiles are bonded to one another by fusion bonding.

Aspect 51. The monolith of Aspect 49, wherein the bricks or tiles are bonded to one another by sintering the bricks or tiles.

Aspect 52. A thermochemical energy storage device comprising:
a vessel defining an interior volume, the vessel comprising at least one inlet and at least one outlet; and
an energy storage material comprising a plurality of the bricks of any one of Aspects 1-46, tiles of Aspects 47-48, or monolith of any one of Aspects 49-51 disposed within the interior volume and in fluid communication with the inlet and the outlet.

Aspect 53. The device of Aspect 52, wherein the plurality of bricks is disposed within the interior volume of the vessel so that at least one gas passage of each brick overlaps with at least one gas passage of an adjacent brick.

Aspect 54. The device of Aspect 52 or 53, wherein between each brick or tile, a paste or powder comprising a second mixed metal oxide is disposed between each brick or tile, wherein the second mixed metal oxide is the same or different mixed metal oxide in the brick or tile, and wherein the paste or powder does not cover the first gas passage opening and the second gas passage opening in the brick.

Aspect 55. The device of Aspect 52, wherein the energy storage material comprises two or more monoliths, wherein each monolith has a first end and a second end, wherein the electrode is in contact with the first end of each monolith, and a high-temperature electrically conductive ceramic plate connecting at least two of the monoliths, where the ceramic plate is in contact with the second end of each monolith.

Aspect 56. The device of any one of Aspects 52-55, wherein the device comprises one or more electrodes, wherein the one or more electrode is in contact with the plurality of bricks.

Aspect 57. A method for producing heated air or gas using the device of any one of Aspects 52-56, the method comprising
heating an energy storage material comprising a plurality of bricks, tiles, or monolith to produce a reduced mixed metal oxide;
introducing an oxygenated gas into the inlet, wherein the air comes into contact with the reduced mixed metal oxide and oxidizes the reduced mixed metal oxide in the plurality of bricks or tiles to produce heated air; and
recovering the heated air or gas that exits the vessel through the outlet.

Aspect 58. The method of Aspect 57, wherein the energy storage material is heated by providing an electrical current through the energy storage material by two or more electrodes.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Preparation of Bricks

Bricks with integrated hole patterns and gas passages were produced directly via dry pressing from granulated powder using a die with ejection plate. Granulated manganese magnesium oxide mixture contains a binder (e.g. PVA) where the binder mass fraction is 0.6%. Granules of the manganese magnesium oxide range in size from 0.1 to 1 mm. The pressure used for dry pressing was 40 MPa.

Firing of the pressed, green bricks is carried out at typical ramp rates of 60° C./h with a hold of several hours for debinding at 400° C. and a maximum firing temperature of up to 1500° C. The maximum firing temperature is held at about 4 hours. Both single, and two-step firing is possible:

Single step firing:
ambient to 1500° C. at 60° C./h, 4 hours hold at 1500° C., cool down at 60° C./h

Two-step firing:
1) ambient to 1150° C. at 60° C./h, >8 hours hold at 1500° C., cool down at 60° C./h
2) ambient to 1500° C. at 60° C./h, 4 hours hold at 1500° C., cool down at 60° C./h
3) ambient to 1500° C. at 120° C./h, 4 hours hold at 1500° C., cool down at 120° C./h

### Cyclability

The bricks produced above were tested for redox performance in tube furnace test stands. 400 g of bricks were machined to cylinders and placed inside an alumina tube housed in a vertical tube furnace. The inlet of the alumina tube is connected to an air supply via a precision air flow controller that maintains 2.7 SLPM. The outlet is connected to an air flow meter and a precision oxygen sensor to measure the amount the oxygen absorbed and released during cycling. The temperatures and ramp rates for the cycling tests are in Table 1 and the description of the brick cycled 100 times are in Table 2.

TABLE 1
Temperature ramp rates during tube furnace cycling tests

| Start | End | Ramp rate |
|---|---|---|
| temperature (° C.) | temperature (° C.) | (° C.) |
| 1000 | 1350 | 3.1 |
| 1350 | 1450 | 1.2 |
| 1450 | 1000 | 2.5 |

TABLE 2
Bricks cycled 100 times in the tube furnace

| | Mg/Mn | | Channel | Channel | Apparent |
|---|---|---|---|---|---|
| Brick | molar | | diameter | spacing | density |
| no. | ratio | Synthesis method | (mm) | (mm) | (g/cc) |
| 1 | 1.5 | Sacrificial channel formation | 3-4 | 6 | 2.14 |
| 2 | 1 | Granulation and pressing | 6-7 | 15 | 2.92 |

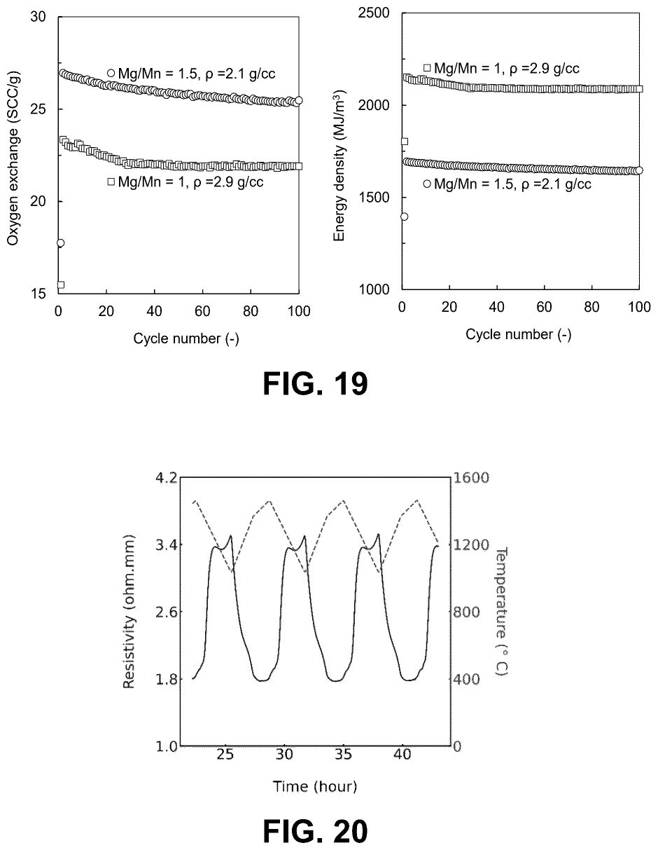

FIG. 18 shows the oxygen absorption and release profile. The oxygen exchange data and the computed energy densities for the bricks cycled 100 times are shown in FIG. 19. The data in FIGS. 18 and 19 demonstrate that magnesium manganese oxide mixed metal oxide can go through several oxidation/reduction cycles, which makes the mixed metal oxide a suitable material for producing the energy storage articles described herein.

### Electrical Resistivity

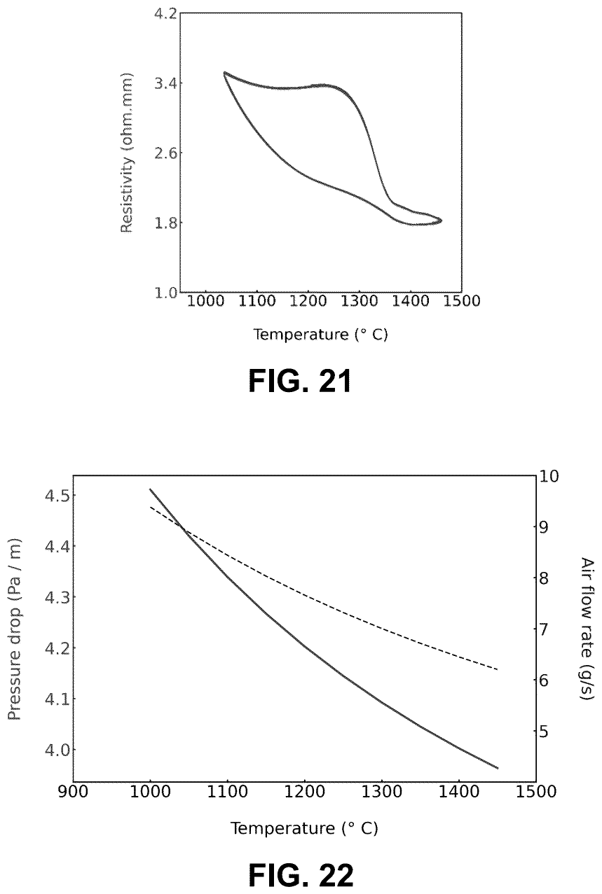

Rectangular samples were extracted from the bricks to perform DC resistivity measurements via the four-wire method. Samples are 30 to 36 mm in length, 4 to 8 mm wide, and 3 to 5 mm thick. The ends are connected to platinum wires and constant DC current (less than 0.1 A) is maintained while the sample heats up and cools down under the conditions given in Table 1. The voltage at two points (10 to 15 mm, 5 to 7.5 cm from the center) was measured and ohms law is used to calculate the resistance which is then used to estimate the resistivity by dividing and multiplying the resistance by the voltage measurement length and cross-sectional area respectively. Typical resistivity of the brick sample is shown in FIGS. 20 and 21. The results demonstrate that the manganese magnesium oxide mixed metal oxide possesses good electrical resistance, which make the mixed metal oxide a good electroconductive material with sufficient resistance for use as a resistive heat source.

### Pressure Drop

The pressure drop across the brick stack using the Darcy-Weisbach model in conjunction with the Afzal equation for friction factor was estimated. Pressure drop calculation is for a 100-kWh module discharging a constant 10 kW for 10 hours. The estimated pressure drop and the total flow rate is shown in FIG. 22. It may be noted that the flow rate decreases with temperature for a constant 10 kW thermal output.

Modifying Brick Performance

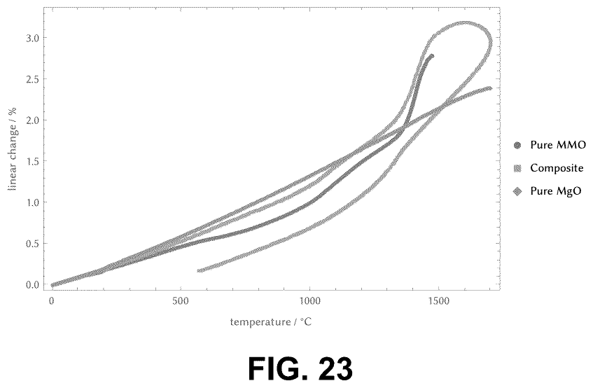

Refractoriness under load (RUL) of the bricks was measured using a using a Netzsch RUL/CIC 421 refractory tester. A composite brick composed of MgMnO and 1-5 mm sized MgO gravel showed superior compressive strength (FIG. 23). Alternatively smaller gravel of approximately 1 mm size can be used. Typical gravel mass fraction is approximately 55% or lower.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A brick comprising
(a) a mixed metal oxide, wherein the mixed metal oxide (i) is reduced when heated to produce a reduced state and (ii) when in the reduced state, the mixed metal oxide is oxidized when exposed to an oxygenated gas, and the mixed metal oxide is electrically conductive; and
(b) the brick comprises at least one pair of parallel surfaces comprising a first surface and a second surface, wherein a plurality of gas passages extends from the first surface to the second surface, and wherein each gas passage has a first gas passage opening and a second gas passage opening.

2. The brick of claim 1, wherein the mixed metal oxide comprises the reaction product between manganese oxide and a metal oxide selected from the group consisting of magnesium oxide, calcium oxide, strontium oxide, barium oxide, yttrium oxide, cerium oxide, lanthanum oxide, and any combination thereof when heated in the presence of oxygen.

3. The brick of claim 2, wherein manganese oxide is MnO, Mn₃O₄, Mn₂O₃, MnO₂, or any combination thereof.

4. The brick of claim 1, wherein the mixed metal oxide comprises the reaction product between iron oxide and a metal oxide selected from the group consisting of magnesium oxide, calcium oxide, strontium oxide, barium oxide, cerium oxide, lanthanum oxide, and any combination thereof when heated in the presence of oxygen.

5. The brick of claim 4, wherein iron oxide is FeO, Fe₃O₄, Fe₂O₃, or any combination thereof.

6. The brick of claim 1, wherein the mixed metal oxide comprises the reaction product between cobalt oxide and a metal oxide selected from the group consisting of magnesium oxide, calcium oxide, strontium oxide, barium oxide, cerium oxide, lanthanum oxide, and any combination thereof when heated in the presence of oxygen.

7. The brick of claim 6, wherein cobalt oxide is CoO, Co₃O₄, or any combination thereof.

8. The brick of claim 1, wherein the mixed metal oxide comprises the reaction product between nickel oxide and a metal oxide selected from the group consisting of lanthanum oxide, praseodymium oxide, neodymium oxide, and any combination thereof when heated in the presence of oxygen.

9. The brick of claim 1, wherein the mixed metal oxide comprises the reaction product between manganese oxide and magnesium oxide when heated in the presence of oxygen.

10. The brick of claim 1, wherein the mixed metal oxide further comprises a dopant.

11. The brick of claim 10, wherein the dopant is selected from the group consisting of aluminum oxide (Al₂O₃), titanium oxide (TiO₂), zirconium oxide (ZrO₂), scandium oxide (Sc₂O₃), hafnium oxide (HfO₂), gadolinium oxide (Gd₂O₃), tantalum oxide (Ta₂O₃), zinc oxide (ZnO), tin dioxide (SnO₂), copper oxide (Cu₂O, CuO), strontium oxide (SrO), lithium oxide (Li₂O), and any combination thereof.

12. The brick of claim 1, wherein the gas passage has a hydraulic diameter from about 3 mm to about 10 mm and each gas passage is spaced from one another at about 8 mm to about 25 mm.

13. The brick of claim 1, the brick has a geometrical surface to volume ratio of the brick is between about 0.02/mm to about 2.0/mm.

14. The brick of claim 1, wherein the brick further comprises a mechanical support phase.

15. The brick of claim 14, wherein the mechanical support phase comprises gravel selected from the group consisting of magnesium oxide, aluminum oxide, naturally occurring corundum, zirconium oxide, yttrium oxide, and any combination thereof.

16. The brick of claim 15, wherein the gravel is from about 5 volume percent to about 50 volume percent of the brick.

17. The brick of claim 14, wherein the mechanical support phase comprises ceramic fibers selected from the group consisting of alumina, magnesium oxide, magnesium aluminate, zirconium oxide, cerium oxide, lanthanum oxide, cerium aluminate, lanthanum aluminate, titanium oxide, calcium titanate, strontium titanate, calcium zirconate, strontium zirconate, or barium zirconate.

18. The brick of claims 17, wherein the fibers are from about 1 volume percent to about 50 volume percent of the brick.

19. The brick of claim 1, wherein the brick is produced by the method comprising
(a) dry pressing a mixed metal oxide in a die comprising a plurality of rods to produce a pressed structure, wherein the mixed metal oxide is (i) reduced when heated to produce a reduced state and (ii) when in the reduced state, the mixed metal oxide is oxidized when exposed to an oxygenated gas; and
(b) heating the pressed structure to produce the brick.

20. A tile comprising
(a) a mixed metal oxide, wherein the mixed metal oxide (i) is reduced when heated to produce a reduced state and (ii) when in the reduced state, the mixed metal oxide is oxidized when exposed to an oxygenated gas; and
(b) the tile comprises at least one pair of parallel surfaces comprising a first surface and a second surface, wherein the first surface and/or the second surface of the tile comprises a plurality of raised members.

21. A monolith comprising a plurality of bricks of claim 1, wherein the bricks are bonded to one another, and wherein the monolith comprises a plurality of channels that traverse from one side of the monolith to the other side of the monolith.

22. The monolith of claim 21, wherein the bricks are bonded to one another by fusion bonding or the bricks are bonded to one another by sintering the bricks.

23. A thermochemical energy storage device comprising:
a vessel defining an interior volume, the vessel comprising at least one inlet and at least one outlet; and
an energy storage material comprising a plurality of the bricks of claim 1 disposed within the interior volume and in fluid communication with the inlet and the outlet.

24. The device of claim 23, wherein the device comprises one or more electrodes, wherein the one or more electrodes is in contact with the plurality of tiles.

25. A thermochemical energy storage device comprising:
a vessel defining an interior volume, the vessel comprising at least one inlet and at least one outlet; and
an energy storage material comprising a plurality of the tiles of claim 20 disposed within the interior volume and in fluid communication with the inlet and the outlet.

26. A thermochemical energy storage device comprising:
a vessel defining an interior volume, the vessel comprising at least one inlet and at least one outlet; and
an energy storage material comprising a monolith of claim 21 disposed within the interior volume and in fluid communication with the inlet and the outlet.

27. The device of claim 26, wherein the device comprises one or more electrodes, wherein the one or more electrodes is in contact with the monolith.

28. A method for producing heated air or gas using the device of claim 23, the method comprising
(a) heating an energy storage material comprising a plurality of bricks to produce a reduced mixed metal oxide;
(b) introducing an oxygenated gas into the inlet, wherein the air comes into contact with the reduced mixed metal oxide and oxidizes the reduced mixed metal oxide in the plurality of bricks to produce heated air; and
(c) recovering the heated air or gas that exits the vessel through the outlet.

29. A method for producing heated air or gas using the device of claim 25, the method comprising
(a) heating an energy storage material comprising a plurality of tiles to produce a reduced mixed metal oxide;
(b) introducing an oxygenated gas into the inlet, wherein the air comes into contact with the reduced mixed metal oxide and oxidizes the reduced mixed metal oxide in the plurality of tiles to produce heated air; and
(c) recovering the heated air or gas that exits the vessel through the outlet.

30. A method for producing heated air or gas using the device of claim 26, the method comprising
(a) heating an energy storage material comprising the monolith to produce a reduced mixed metal oxide;
(b) introducing an oxygenated gas into the inlet, wherein the air comes into contact with the reduced mixed metal oxide and oxidizes the reduced mixed metal oxide in the monolith to produce heated air; and
(c) recovering the heated air or gas that exits the vessel through the outlet.
